(19) United States
(12) Patent Application Publication
(10) Pub. No.: US 2025/0059094 A1
(43) Pub. Date: Feb. 20, 2025

(54) DIELECTRIC COMPOSITION AND ELECTRONIC COMPONENT

(71) Applicant: TDK CORPORATION, Tokyo (JP)

(72) Inventors: Toshihiro IGUCHI, Tokyo (JP); Kenichiro Masuda, Tokyo (JP); Tetsuya Yoshiyama, Tokyo (JP); Toshio Asahi, Tokyo (JP)

(73) Assignee: TDK CORPORATION, Tokyo (JP)

(21) Appl. No.: 18/762,275

(22) Filed: Jul. 2, 2024

(30) Foreign Application Priority Data
Aug. 18, 2023 (JP) 2023-133534

(51) Int. Cl. C04B 35/468; H01G 4/12

(52) U.S. Cl. CPC C04B 35/468; H01G 4/1227; C04B 2235/3236; C04B 2235/781

(57) ABSTRACT

A dielectric composition includes main phase grains and segregation grains. The segregation grains at least partly include RE-Mg—Ti—O segregation grains including “RE”, Mg, Ti, and O. “RE” includes a rare earth element. “RE”, Mg, and Ti in the RE-Mg—Ti—O segregation grains constitute 70 parts by mol or more in total out of 100 parts by mol of a total of metal elements in the RE-Mg—Ti—O segregation grains. A ratio of Mg to a total of “RE” and Mg in the RE-Mg—Ti—O segregation grains ranges from 0.1 to 0.3.

The present application claims a priority to Japanese patent application No. 2023-133534 filed on Aug. 18, 2023, which is incorporated herein by reference in its entirety.

### TECHNICAL FIELD

The present invention relates to a dielectric composition and an electronic component including a dielectric layer containing the dielectric composition.

### BACKGROUND

An electronic circuit or a power supply circuit incorporated in an electronic device includes many electronic components, such as a multilayer ceramic capacitor utilizing dielectric properties of a dielectric. Patent Document 1 (JP Patent Application Laid Open No. 2001-6966) discloses that a main component of a dielectric ceramic of an electronic component is a composition represented by a general formula ABO₃ (where A is at least one selected from Ba, Sr, Ca, and Mg, and B is at least one selected from Ti, Zr, and Hf).

A conventional electronic component shown in Patent Document 1 is mounted on a circuit board or the like using reflow soldering, flow soldering, etc. Although flow soldering is advantageous in reducing costs compared to reflow soldering, when flow soldering is used to mount the electronic component on the circuit board, cracks may be generated in a dielectric composition (dielectric ceramic) of the electronic component due to thermal shock or the like. Thus, development of a dielectric composition that can be effectively prevented from cracking due to thermal shock or the like has been in demand.

### SUMMARY

The present invention has been achieved in view of such circumstances. It is an object of the present invention to provide a dielectric composition that can be prevented from cracking due to thermal shock or the like.

To achieve the above object, a dielectric composition according to the present invention is a dielectric composition including:
main phase grains; and
segregation grains,
wherein
the segregation grains at least partly include RE-Mg—Ti—O segregation grains including
“RE”, Mg, Ti, and O;
“RE” includes a rare earth element;
“RE”, Mg, and Ti in the RE-Mg—Ti—O segregation grains constitute 70 parts by mol or more in total out of 100 parts by mol of a total of metal elements in the RE-Mg—Ti—O segregation grains; and
a ratio of Mg to a total of “RE” and Mg in the RE-Mg—Ti—O segregation grains ranges from 0.1 to 0.3.

The present inventors have diligently sought to achieve a dielectric composition that can be prevented from cracking due to thermal shock or the like. The present inventors have finally found that the dielectric composition including the RE-Mg—Ti—O segregation grains has excellent effects of preventing or mitigating cracks and completed the present invention.

It is assumed that a reason why the RE-Mg—Ti—O segregation grains can prevent or mitigate cracks due to thermal shock or the like is, for example, that the RE-Mg—Ti—O segregation grains prevent or mitigate excessive grain growth of the main phase grains.

It is also assumed that, even if cracks are generated in the dielectric composition, progression of the cracks are stopped when the cracks reach the RE-Mg—Ti—O segregation grains.

The RE-Mg—Ti—O segregation grains may be present in a grain boundary between the main phase grains.

Preferably, the RE-Mg—Ti—O segregation grains have an average grain size of 0.1 μm or less.

Preferably, an average number of the RE-Mg—Ti—O segregation grains observed in a total of 5 μm² or more of a section of the dielectric composition is 0.2 to 2 per μm².

Because making the RE-Mg—Ti—O segregation grains finer to increase their surface area can increase surface energy, even a small amount of the RE-Mg—Ti—O segregation grains can efficiently prevent or mitigate movement of the grain boundary between the main phase grains and can further prevent or mitigate excessive grain growth of the main phase grains. Consequently, cracks can be less readily generated.

Moreover, because the amount of the RE-Mg—Ti—O segregation grains is small, the RE-Mg—Ti—O segregation grains do not completely block a space between the main phase grains. Thus, thermal conductivity between the main phase grains is readily ensured, and thermal conductivity of the dielectric composition as a whole is increased, which makes the dielectric composition thermal shock resistant. Consequently, cracks due to thermal shock can be further prevented or mitigated.

Furthermore, when the average number of the RE-Mg—Ti—O segregation grains is within the above range, higher relative permittivity can be maintained compared to when the average number exceeds the above range. It is assumed that, when the average number of the RE-Mg—Ti—O segregation grains is within the above range, the main phase grains, which mainly exhibit dielectric properties, are sufficiently present in the dielectric composition to increase relative permittivity.

Preferably, the main phase grains have a composition of BaTiO₃.

Preferably, the RE-Mg—Ti—O segregation grains have a composition of {RE₍₁₋ₐ₎Mgₐ}₂Ti₂O₇₋ₐ, where “a” ranges from 0.1 to 0.3.

An electronic component of the present invention includes a dielectric layer containing the dielectric composition according to the present invention.

### BRIEF DESCRIPTION OF THE DRAWING(S)

FIG. 1A is a sectional view of a multilayer ceramic capacitor according to one embodiment of the present invention.

FIG. 1B is a sectional view of the multilayer ceramic capacitor along line IB-IB shown in FIG. 1A.

FIG. 2 is a schematic sectional view of a dielectric composition according to the one embodiment of the present invention.

### DETAILED DESCRIPTION

### <Multilayer Ceramic Capacitor>

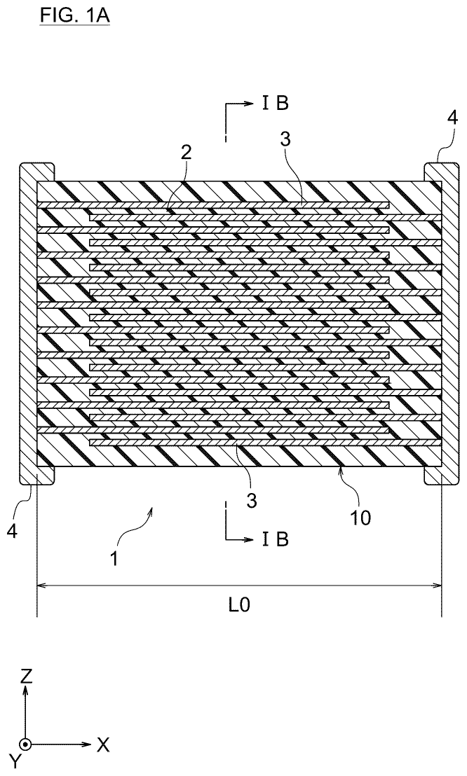

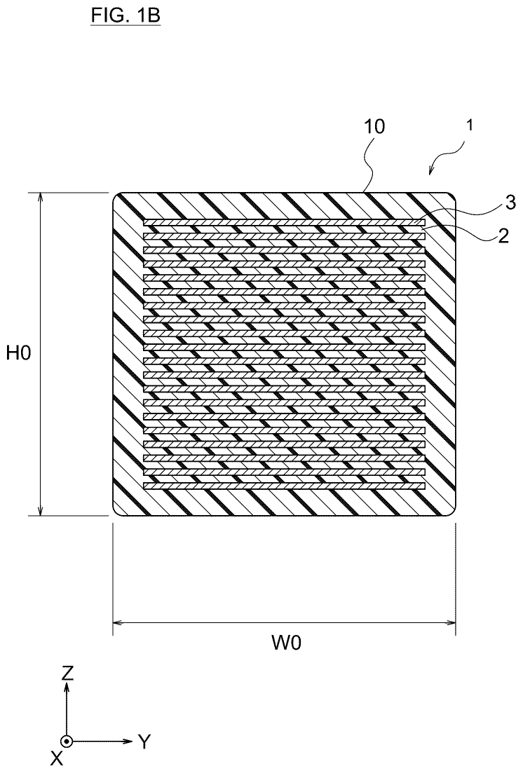

FIGS. 1A and 1B show a multilayer ceramic capacitor 1 as an example electronic component according to the present embodiment. The multilayer ceramic capacitor 1 includes an element body 10 having dielectric layers 2 and internal electrode layers 3 laminated alternately. On both ends of the element body 10, a pair of external electrodes 4 is formed. The external electrodes 4 are electrically connected to the internal electrode layers 3 alternately arranged inside the element body 10. The element body 10 may have any shape but normally has a rectangular parallelepiped shape. The element body 10 may have any dimensions. The dimensions are appropriately determined based on usage.

In the present embodiment, the element body 10 preferably has a lengthwise dimension L0 (see FIG. 1A) of 3.5 to 0.4 mm and a widthwise dimension W0 (see FIG. 1B) of 2.7 to 0.2 mm.

Examples of specific L0×W0 sizes of the element body 10 include (3.2±0.3) mm×(2.5±0.2) mm, (3.2±0.3) mm×(1.6±0.2) mm, (2.0±0.2) mm×(1.2±0.1) mm, (1.6±0.2) mm×(0.8±0.1) mm, (1.0±0.1) mm×(0.5±0.05) mm, (0.6±0.06) mm×(0.3±0.03) mm, and (0.4±0.04) mm×(0.2±0.02) mm. H0 is not limited and is, for example, approximately equivalent to or smaller than W0.

The dielectric layers 2 include a dielectric composition (described later) according to the present embodiment.

The dielectric layers 2 may each have any thickness (inter-layer thickness). The inter-layer thickness can be determined based on desired properties, usage, etc. Normally, the inter-layer thickness is preferably 30 μm or less, more preferably 10 μm or less, or still more preferably 5 μm or less. The number of the dielectric layers 2 is not limited. In the present embodiment, the number of the dielectric layers 2 is preferably, for example, twenty or more.

In the present embodiment, the internal electrode layers 3 are laminated so that their ends are alternately exposed to surfaces of two end surfaces of the element body 10 facing each other.

The internal electrode layers 3 may have any thickness. The thickness is, for example, 2 μm or less or preferably 1.5 μm or less.

The internal electrode layers 3 may include any conductive material. Examples of noble metals that may be used as the conductive material include Pd, Pt, and Ag—Pd alloys. Examples of base metals that may be used as the conductive material include Ni, Ni based alloys, Cu, and Cu based alloys. Ni, Ni based alloys, Cu, or Cu based alloys may contain about 0.1 mass % or less various trace components, such as P and/or S. A commercially available electrode paste may be used to form the internal electrode layers 3. The thickness of the internal electrode layers 3 is determined appropriately based on usage or the like.

The external electrodes 4 may include any conductive material. For example, a known conductive material, such as Ni, Cu, Sn, Ag, Pd, Pt, Au, their alloys, or conductive resin, is used. The thickness of the external electrodes 4 is determined appropriately based on usage or the like.

### <Dielectric Composition>

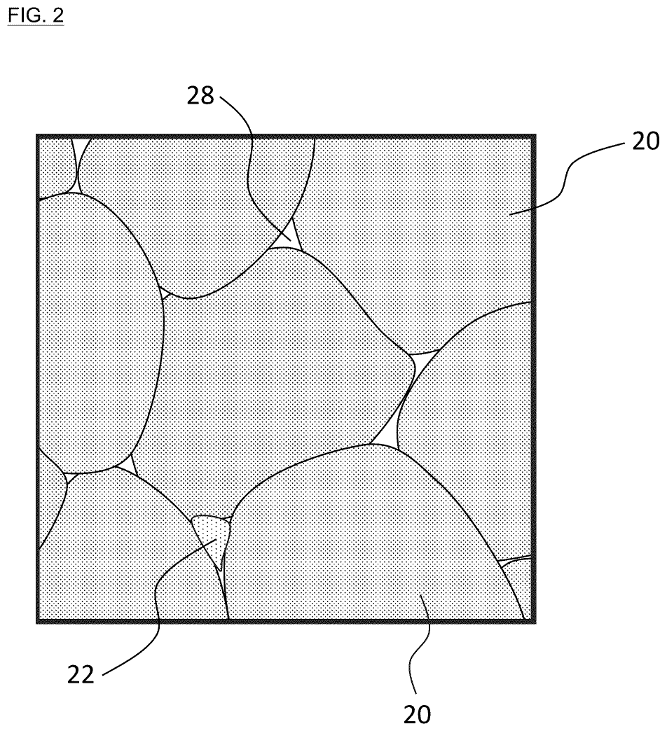

As shown in FIG. 2, the dielectric composition constituting the dielectric layers 2 includes main phase grains 20 and RE-Mg—Ti—O segregation grains 22. The RE-Mg—Ti—O segregation grains 22 contain “RE”, Mg, Ti, and O. “RE” indicates at least one rare earth element. The RE-Mg—Ti—O segregation grains 22 may be present in a grain boundary 28 between the main phase grains 20.

In the present embodiment, segregation grains included in the dielectric composition at least partly include the RE-Mg—Ti—O segregation grains 22; and the dielectric composition may include segregation grains having a composition different from the RE-Mg—Ti—O segregation grains 22.

### <Main Phase Grains>

The main phase grains 20 of the present embodiment contain a compound represented by AMO₃ as a main component. The main component of the main phase grains 20 is a component constituting 80 to 100 parts by mass or preferably 90 to 100 parts by mass out of 100 parts by mass of the main phase grains 20.

A molar ratio of “A” to “M” represented by (molar ratio of “A”/molar ratio of “M”) may be 1 or may not be 1. Preferably, (molar ratio of “A”/molar ratio of “M”) is 0.9 to 1.2.

“A” includes at least one selected from the group consisting of Ba and Ca. Preferably, “A” is Ba. This enables the dielectric composition to exhibit higher relative permittivity.

When “A” includes Ba and Ca, the Ba content is preferably 0.9 to 1 part by mol out of 1 part by mol of the total of Ba and Ca.

“M” includes at least one selected from the group consisting of Ti and Zr. Preferably, “M” is Ti. This enables the dielectric composition to exhibit higher relative permittivity.

When “M” includes Ti and Zr, the Ti content is preferably 0.8 to 1 part by mol out of 1 part by mol of the total of Ti and Zr.

The main phase grains 20 may further contain, for example, Mg, Mn, Cr, Si, “RE”, V, Li, B, or Al.

### <RE-Mg—Ti—O Segregation Grains>

The RE-Mg—Ti—O segregation grains 22 contain “RE”, Mg, Ti, and O.

“RE” indicates at least one rare earth element. “RE” is not limited and can include, for example, Y, Dy, or Ho. “RE” may include only one element or may include two or more elements.

“RE”, Mg, and Ti in the RE-Mg—Ti—O segregation grains 22 constitute 70 parts by mol or more in total out of 100 parts by mol of the total of metal elements in the RE-Mg—Ti—O segregation grains 22.

The ratio {Mg/(RE+Mg)} of Mg to the total of “RE” and Mg in the RE-Mg—Ti—O segregation grains 22 ranges from 0.1 to 0.3.

The ratio {Ti/(RE+Mg)} of Ti to the total of “RE” and Mg in the RE-Mg—Ti—O segregation grains 22 preferably ranges from 0.7 to 1.3.

The RE-Mg—Ti—O segregation grains 22 may have any composition. The composition may be, for example, {RE₍₁₋ₐ₎Mgₐ}₂Ti₂O₇₋ₐ, where “a” may range from 0.1 to 0.3.

The RE-Mg—Ti—O segregation grains 22 have an average grain size of preferably 0.1 μm or less or more preferably 0.05 μm or less. The average grain size of the RE-Mg—Ti—O segregation grains 22 may be an average of the equivalent circle diameters of the RE-Mg—Ti—O segregation grains 22.

When a total of 5 μm² or more of a section of the dielectric composition is observed, an average number of the RE-Mg—Ti—O segregation grains 22 observed is preferably 0.2 to 2 per μm² or is more preferably 0.5 to 1.5 per μm². “When a total of 5 μm² or more of a section of the dielectric composition is observed” means “when one field of view having an area of 5 μm² or more is observed” in the case where there is one field of view of interest or means “when fields of view having an area of 5 μm² or more in total are observed” in the case where there are two or more fields of view of interest.

Each of the RE-Mg—Ti—O segregation grains 22 included in their entirety in one field of view is counted as one RE-Mg—Ti—O segregation grain 22. For example, the RE-Mg—Ti—O segregation grains 22 that are at an edge of the field of view and are observed as partially missing are not counted.

Preferably, the RE-Mg—Ti—O segregation grains 22 have a tetragonal crystal system.

Preferably, the RE-Mg—Ti—O segregation grains 22 have a space group of [Mathematical 1].

Fm3̅m [Mathematical 1]

### <Method of Confirming Segregation Grains>

Any method of determining whether the dielectric composition constituting the dielectric layers 2 includes the RE-Mg—Ti—O segregation grains 22 may be used. A specific example method is described below.

First, a section of the dielectric composition is photographed using a scanning transmission electron microscope (STEM) to give a dark-field (DF) image. The size of a field of view for photographing is not limited, and the field of view measures, for example, about 1 to 10 μm on all four sides. Regions having contrast different from the main phase grains 20 in this dark-field image are identified as secondary phases. Whether there are contrast differences, i.e., whether secondary phases are included, may be determined visually or using image processing software or the like.

Then, various elements of the above secondary phases are measured using energy dispersive X-ray spectroscopy (EDS spectroscopy).

When “RE”, Mg, Ti, and O are present at the same location in the secondary phases; “RE”, Mg, and Ti in the secondary phases constitute 70 parts by mol or more in total out of 100 parts by mol of the total of metal elements in the secondary phases; and Mg/(RE+Mg) of the secondary phases is 0.1 to 0.3, it can be determined that the secondary phases are the RE-Mg—Ti—O segregation grains 22.

Other than that, an elemental mapping image can be used to determine that the secondary phases are the RE-Mg—Ti—O segregation grains 22.

### <Method of Manufacturing Multilayer Ceramic Capacitor>

An example method of manufacturing the multilayer ceramic capacitor 1 shown in FIGS. 1A and 1B is described below.

In the present embodiment, prepared are a calcined powder of AMO₃, which is the main component of the main phase grains 20 constituting the above dielectric composition, and a calcined powder of a raw material mixture of the RE-Mg—Ti—O segregation grains 22.

The calcined powder of AMO₃ is a calcined powder of “A” and “M” constituting the main phase grains 20 after firing.

The calcined powder of the raw material mixture of the RE-Mg—Ti—O segregation grains 22 is a calcined powder of “RE”, Mg, and Ti constituting the RE-Mg—Ti—O segregation grains 22 after firing.

Raw materials of the above elements are not limited, and oxides of the elements can be used. Alternatively, various compounds that can give oxides of the elements by firing can be used. Examples of the various compounds include carbonates, oxalates, nitrates, hydroxides, and organic metal compounds. In the present embodiment, the above starting raw materials are preferably powders.

Among the prepared starting raw materials, the raw materials of the AMO₃ grains are weighed at a predetermined ratio and are then wet-mixed using a ball mill or the like for a predetermined amount of time. The mixed powder is dried and is then subject to a heat treatment in air within the range of 700 to 1300° C. to give the calcined powder of the raw material mixture of the AMO₃ grains. The calcined powder may be pulverized for a predetermined amount of time using a ball mill or the like.

Various compounds, such as oxides of the elements constituting the RE-Mg—Ti—O segregation grains 22 after firing, are prepared, are subject to a heat treatment, and are then pulverized for a predetermined amount of time using a ball mill or the like to give the calcined powder of the raw material mixture of the RE-Mg—Ti—O segregation grains 22.

For example, changing the pulverization time can change the grain sizes of the RE-Mg—Ti—O segregation grains 22; and the longer the pulverization time, the smaller the grain sizes of the RE-Mg—Ti—O segregation grains 22 can be. Also, changing the media size of the ball mill can change the grain sizes of the RE-Mg—Ti—O segregation grains 22.

Subsequently, a paste for preparing green chips is prepared. The calcined powder of the raw material mixture of the AMO₃ grains, the calcined powder of the raw material mixture of the RE-Mg—Ti—O segregation grains 22, a binder, and a solvent are kneaded into paint to prepare a dielectric layer paste. The binder and the solvent are known ones.

The dielectric layer paste may include additives, such as a plasticizer and a dispersant, as necessary.

An internal electrode layer paste is prepared by kneading a raw material of the above-mentioned conductive material, a binder, and a solvent. The binder and the solvent are known ones. The internal electrode layer paste may include additives, such as an inhibitor and a plasticizer, as necessary.

An external electrode paste can be prepared similarly to the internal electrode layer paste.

Using the pastes, green sheets are formed, and internal electrode patterns are formed on the green sheets. The green sheets with the internal electrode patterns are laminated to give a multilayer body. Subsequently, the multilayer body is cut to give green chips.

The green chips are subject to a binder removal treatment as necessary. As for the binder removal treatment conditions, for example, the holding temperature is preferably 200 to 350° C.

After the binder removal treatment, each of the green chips is fired to give the element body 10. In the present embodiment, the firing atmosphere is not limited and may be air or a reducing atmosphere. In the present embodiment, the holding temperature during firing is not limited and is, for example, 1200 to 1350° C.

After firing, the element body 10 is subject to a reoxidation treatment (annealing) as necessary. As for the annealing conditions, for example, the oxygen partial pressure during annealing is preferably higher than the oxygen partial pressure during firing, and the holding temperature is preferably 1150° C. or less.

The dielectric composition constituting the dielectric layers 2 of the element body 10 manufactured as above is equivalent to the above-mentioned dielectric composition. The end surfaces of the element body 10 are polished, and the external electrode paste is applied there and is baked. This forms the external electrodes 4. On surfaces of the external electrodes 4, a coating layer is formed by plating or the like as necessary.

In this manner, the multilayer ceramic capacitor 1 according to the present embodiment is manufactured.

### Summary of Present Embodiment

One of the reasons of cracks of a dielectric composition is excessive grain growth of main phase grains 20. That is, excessive grain growth of the main phase grains 20 readily generates pores in the dielectric composition; and cracks originating from the pores may be generated by application of thermal shock provided by, for example, flow soldering.

Thus, to prevent or mitigate cracks of the dielectric composition, prevention or mitigation of excessive grain growth of the main phase grains 20 has been desired.

One method of preventing or mitigating excessive grain growth of the main phase grains 20 is a method using a pinning effect by second phase grains. The pinning effect is a phenomenon of prevention or mitigation of grain growth of first phase grains (the main phase grains 20 in the present embodiment) due to prevention or mitigation of movement of the grain boundary 28 by the second phase grains. Thus, the present inventors have explored a method of making grains serving as the second phase grains be present in the dielectric composition.

RE₂O₃ or MgO may dissolve in AMO₃ because a solid solution of RE₂O₃ or MgO and AMO₃ is easily formed when only RE₂O₃ or MgO is mixed with AMO₃. Thus, it is not easy for only RE₂O₃ or MgO to be present as the second phase grains, which exhibit the pinning effect in the dielectric composition.

Further, while RE₂O₃ and MgO form a solid solution and partly substitute for each other, other than that, they do not form a compound. Thus, because the solid solution of RE₂O₃ and MgO dissolves in AMO₃ similarly to the behavior of RE₂O₃ or the behavior of MgO, it is not easy for the solid solution of RE₂O₃ and MgO to be present as the second phase grains, which exhibit the pinning effect in the dielectric composition.

In this regard, the present inventors have found that generating the RE-Mg—Ti—O segregation grains 22 from RE₂O₃, MgO, and TiO₂ provides the second phase grains. Because the RE-Mg—Ti—O segregation grains 22 are stable compounds, it is assumed that they are difficult to dissolve in the main phase grains 20 having AMO₃ as the main component. Thus, presence of the RE-Mg—Ti—O segregation grains 22 in the grain boundary 28 between the main phase grains 20 can efficiently prevent or mitigate movement of the grain boundary 28 between the main phase grains 20, allowing prevention or mitigation of grain growth of the main phase grains 20, due to the pinning effect. Consequently, cracks due to thermal shock or the like can be less readily generated.

Even if cracks are generated in the dielectric composition, progression of the cracks are stopped when the cracks reach the RE-Mg—Ti—O segregation grains 22. That is, the RE-Mg—Ti—O segregation grains 22 can stop progression of the cracks.

Further, because making the RE-Mg—Ti—O segregation grains 22 finer to increase their surface area can increase surface energy, even a small amount of the RE-Mg—Ti—O segregation grains 22 between the main phase grains 20 can efficiently prevent or mitigate movement of the grain boundary 28 between the main phase grains 20, can prevent or mitigate grain growth of the main phase grains 20 to generate less cracks, and can stop progression of the cracks.

Moreover, because the RE-Mg—Ti—O segregation grains 22 do not completely block a space between the main phase grains 20 when the amount of the RE-Mg—Ti—O segregation grains 22 is small, thermal conductivity between the main phase grains 20 is readily ensured, and thermal conductivity of the dielectric composition as a whole is increased, which makes the dielectric composition thermal shock resistant. Consequently, cracks due to thermal shock can be further prevented or mitigated.

While the embodiment of the present invention has been described above, the present invention is not at all limited to the above embodiment. The present invention may be modified into various forms without departing from the scope of the invention.

While the above embodiment describes a case where a multilayer ceramic capacitor exemplifies an electronic component according to the present invention, the electronic component according to the present invention is not limited to the multilayer ceramic capacitor and may be any other electronic component including the above dielectric composition.

The electronic component according to the present invention may be, for example, a single plate type ceramic capacitor having a pair of electrodes formed on the above dielectric composition.

### EXAMPLES

Hereinafter, the present invention is described in further detail with Examples and Comparative Examples. However, the present invention is not limited to Examples described below.

As starting raw materials of main phase grains 20 included in a dielectric composition, powders of BaCO₃, CaCO₃, ZrO₂, and TiO₂ were prepared. The prepared starting raw materials were weighed so that the main phase grains 20 after firing had a main component shown in Tables 1, 2, and 4.

Then, the weighed powders were wet-mixed for 16 hours in a ball mill using ion-exchanged water as a dispersion medium; and this mixture was dried to give a mixed raw material powder. After that, the mixed raw material powder was subject to a heat treatment at a holding temperature of 1000° C. in air for a holding time of 2 hours and was wet-pulverized for 16 hours in a ball mill using ion-exchanged water as a dispersion medium; and this mixture was dried to give a calcined powder of a raw material mixture of the main phase grains 20.

Also, as raw materials of RE-Mg—Ti—O segregation grains 22, powders of an “RE” oxide (Y₂O₃), MgCO₃, and TiO₂ were prepared. The prepared starting raw materials were weighed so that Ti/(RE+Mg) and Mg/(RE+Mg) of the RE-Mg—Ti—O segregation grains 22 were as shown in Tables 1, 2, and 4 and that the amount (unit: parts by mass) (denoted by “Amount” in Tables 1, 2, and 4) of a calcined powder of a raw material mixture of the RE-Mg—Ti—O segregation grains 22 with respect to 100 parts by mass of the calcined powder of the raw material mixture of the main phase grains 20 was as shown in Tables 1, 2, and 4.

Also, as raw materials of the RE-Mg—Ti—O segregation grains 22, powders of an “RE” oxide (Y₂O₃), MgCO₃, and TiO₂ were prepared. The prepared powders were weighed so that Ti/(RE+Mg) and Mg/(RE+Mg) of the RE-Mg—Ti—O segregation grains 22 were as shown in Tables 1, 2, and 4.

Then, the weighed powders were wet-mixed for 16 hours in a ball mill using ion-exchanged water as a dispersion medium. This mixture was dried, was subject to a heat treatment at a holding temperature of 1000° C. in air for a holding time of 2 hours, and was wet-pulverized for 16 hours in a ball mill using ion-exchanged water as a dispersion medium. The resulting mixture was dried to give the calcined powder of the raw material mixture of the RE-Mg—Ti—O segregation grains 22.

Further, an inorganic additive was prepared as follows. Powders of MgCO₃, Y₂O₃, MnCO₃, SiO₂, and V₂O₅ were wet-mixed for 16 hours in a ball mill using ion-exchanged water as a dispersion medium to give a mixture. Then, the mixture was dried and was subject to a heat treatment at a holding temperature of 900° C. in air for a holding time of 2 hours. The mixture after the heat treatment was wet-pulverized for 16 hours in a ball mill using ion-exchanged water as a dispersion medium and was dried to give the inorganic additive.

Subsequently, the calcined powder of the raw material mixture of the main phase grains 20, the calcined powder of the raw material mixture of the RE-Mg—Ti—O segregation grains 22, the inorganic additive, a binder, and a solvent were kneaded into paint to prepare a dielectric layer paste. The prepared starting raw materials were weighed so that, at this time, the amount (unit: parts by mass) (denoted by “Amount” in Tables 1, 2, and 4) of the calcined powder of the raw material mixture of the RE-Mg—Ti—O segregation grains 22 with respect to 100 parts by mass of the calcined powder of the raw material mixture of the main phase grains 20 was as shown in Tables 1, 2, and 4.

56 parts by mass nickel particles, 40 parts by mass terpineol, 4 parts by mass ethyl cellulose (molecular weight: 140,000), and 1 part by mass benzotriazole were kneaded using a triple-roll mill and made into a paste to prepare an internal electrode layer paste.

Then, using the dielectric layer paste prepared above, green sheets were formed on PET films. The internal electrode layer paste was screen printed on the green sheets to give green sheets with internal electrode patterns.

The green sheets were laminated and bonded with pressure to give a green laminated body. The green laminated body was cut into predetermined sizes to give green chips.

The green chips were subject to a binder removal treatment, were fired in a reducing atmosphere, and were further subject to an annealing treatment to give sintered bodies (dielectric composition) fired in the reducing atmosphere. As for the firing conditions, the heating rate was 200° C./h, the holding temperature was 1250° C., and the holding time was 2 hours. The ambient gas was a mixed gas (hydrogen concentration: 3%) of nitrogen and hydrogen humidified to a dew point of 20° C. As for the annealing treatment conditions, the holding temperature was 1050° C., and the holding time was 2 hours. The ambient gas was a nitrogen gas humidified to a dew point of 20° C.

End surfaces of the element bodies 10 manufactured as above were polished, and an external electrode paste was applied there and was baked to form external electrodes 4.

In such a manner, multilayer ceramic capacitors 1 (referred to as “capacitor samples” below) were manufactured.

### <Observation of Main Phase Grains>

The main phase grains 20 in a field of view (1.7 μm×1.7 μm) of a section of the dielectric composition of the capacitor samples were identified using a STEM, and a main component of the main phase grains 20 was identified using EDS. Tables 1, 2, and 4 show the results.

### <Observation of Segregation Grains>

Secondary phases in the field of view (1.7 μm×1.7 μm) of the section of the dielectric composition of the capacitor samples were identified using a STEM; and contents of Y, Mg, and Ti were measured using EDS.

When Y, Mg, and Ti were present at the same location in the secondary phases; Y, Mg, and Ti constituted 70 parts by mol or more in total out of 100 parts by mol of the total of metal elements in the secondary phases; and Mg/(RE+Mg) of the secondary phases was 0.1 to 0.3, it was determined that the secondary phases were the RE-Mg—Ti—O segregation grains 22. Tables 1, 2, and 4 show whether the RE-Mg—Ti—O segregation grains 22 were included, Ti/(RE+Mg), and Mg/(RE+Mg). Note that, it was confirmed that, in the capacitor samples including the RE-Mg—Ti—O segregation grains 22, the RE-Mg—Ti—O segregation grains 22 were present in a grain boundary 28 between the main phase grains 20.

### <320° C. Thermal Shock Test>

The capacitor samples were immersed in a flux and were then pinched with tweezers to be immersed in a 320° C. solder bath. After that, the capacitor samples were taken out and were subject to ultrasonic cleaning using thinner, and then their appearance was observed. Twenty capacitor samples were subject to this test. Tables 1, 3, and 5 show the number of capacitor samples in which cracks were generated.

### <Average Grain Size>

Samples shown in Tables 3 and 5 were subject to average grain size measurement. Specifically, a total of 5 μm² or more of a section of the dielectric composition was observed, and equivalent circle diameters of the Y—Mg—Ti—O segregation grains 22 observed were measured to find their average. The average was defined as the average grain size of the Y—Mg—Ti—O segregation grains 22. Tables 3 and 5 show the results.

### <350° C. Thermal Shock Test>

Samples shown in Tables 3 and 5 were subject to a 350° C. thermal shock test. Specifically, the capacitor samples were immersed in a flux and were then pinched with tweezers to be immersed in a 350° C. solder bath. After that, the capacitor samples were taken out and were subject to ultrasonic cleaning using thinner, and then their appearance was observed. Twenty capacitor samples were subject to this test. Tables 3 and 5 show the number of capacitor samples in which cracks were generated.

### <380° C. Thermal Shock Test>

Samples shown in Tables 3 and 5 were subject to a 380° C. thermal shock test. Specifically, the capacitor samples were immersed in a flux and were then pinched with tweezers to be immersed in a 380° C. solder bath. After that, the capacitor samples were taken out and were subject to ultrasonic cleaning using thinner, and then their appearance was observed. Twenty capacitor samples were subject to this test. Tables 3 and 5 show the number of capacitor samples in which cracks were generated.

### <Average Number of Grains>

Samples shown in Table 5 were subject to measurement of the average number of grains. Specifically, a total of 5 μm² or more of a section of the dielectric composition was observed, and the average number of the RE-Mg—Ti—O segregation grains 22 observed was calculated. Table 5 shows the results.

### <Relative Permittivity>

Samples shown in Table 5 were subject to relative permittivity measurement. Specifically, a signal with a frequency of 1 kHz and an input signal level (measurement voltage) of 1 Vrms was applied to the capacitor samples at room temperature (20° C.) using a digital LCR meter (4284A manufactured by YHP) to measure capacitance (“C”). Then, based on the thickness of the sintered bodies, the effective electrode area, and the measured capacitance (“C”), relative permittivity was calculated. Table 5 shows the results.

TABLE 1

| | | Segregation grains | | | | | |
|---|---|---|---|---|---|---|---|
| | | | Whether | | | | |
| | | Elements | RE-Mg-Ti-O | | | | 320° C. |
| | | included as | segregation | | | Amount | thermal |
| Sample | Main component of | main | grains are | Ti/ | Mg/ | [parts by | shock |
| No. | main phase grains | component | included | (RE + Mg) | (RE + Mg) | mass] | test |
| 1 | BaTiO₃ | — | No | — | — | — | 5/20 |
| 2 | BaTiO₃ | Y, Ti, O | No | 1 | 0 | 4 | 6/20 |
| 3 | BaTiO₃ | Mg, Ti, O | No | 1 | 1 | 4 | 8/20 |
| 4 | BaTiO₃ | Y, Mg, Ti, O | No | 1 | 0.06 | 4 | 1/20 |
| 5 | BaTiO₃ | Y, Mg, Ti, O | Yes | 1 | 0.11 | 4 | 0/20 |
| 6 | BaTiO₃ | Y, Mg, Ti, O | Yes | 1 | 0.2 | 4 | 0/20 |
| 7 | BaTiO₃ | Y, Mg, Ti, O | Yes | 1 | 0.29 | 4 | 0/20 |
| 8 | BaTiO₃ | Y, Mg, Ti, O | No | 1 | 0.35 | 4 | 1/20 |
| 9 | (Ba, Ca)(Zr, Ti)O₃ | Y, Mg, Ti, O | Yes | 1 | 0.19 | 4 | 0/20 |
| 10 | (Ba, Ca)TiO₃ | Y, Mg, Ti, O | Yes | 1 | 0.23 | 4 | 0/20 |

TABLE 2

| | Main | Segregation grains | | | |
|---|---|---|---|---|---|
| | component | Whether | | | |
| | of main | RE—Mg—Ti—O | Ti/ | Mg/ | Amount |
| Sample | phase | segregation grains | (RE + | (RE + | [parts by |
| No. | grains | are included | Mg) | Mg) | mass] |
| 11 | BaTiO₃ | Yes | 1 | 0.22 | 4 |
| 12 | BaTiO₃ | Yes | 1 | 0.2 | 4 |
| 13 | BaTiO₃ | Yes | 1 | 0.2 | 4 |
| 6 | BaTiO₃ | Yes | 1 | 0.2 | 4 |

TABLE 3

| | | 320° C. | 350° C. | 380° C. |
|---|---|---|---|---|
| | Average | thermal | thermal | thermal |
| Sample | grain size | shock | shock | shock |
| No. | [μm] | test | test | test |
| 11 | 0.182 | 0/20 | 2/20 | 8/20 |
| 12 | 0.098 | 0/20 | 0/20 | 2/20 |
| 13 | 0.045 | 0/20 | 0/20 | 0/20 |
| 6 | 0.020 | 0/20 | 0/20 | 0/20 |

TABLE 4

| | Main | Segregation grains | | | |
|---|---|---|---|---|---|
| | component | Whether | | | |
| | of main | RE—Mg—Ti—O | Ti/ | Mg/ | Amount |
| Sample | phase | segregation grains | (RE + | (RE + | [parts by |
| No. | grains | are included | Mg) | Mg) | mass] |
| 21 | BaTiO₃ | Yes | 1 | 0.2 | 4 |
| 22 | BaTiO₃ | Yes | 1 | 0.21 | 4 |
| 23 | BaTiO₃ | Yes | 1 | 0.21 | 4 |
| 6 | BaTiO₃ | Yes | 1 | 0.2 | 4 |
| 24 | BaTiO₃ | Yes | 1 | 0.2 | 4 |
| 25 | BaTiO₃ | Yes | 1 | 0.21 | 4 |
| 26 | BaTiO₃ | Yes | 1 | 0.16 | 4 |

TABLE 5

| | Average | Average | 320° C. | 350° C. | 380° C. | |
|---|---|---|---|---|---|---|
| | grain | number | thermal | thermal | thermal | |
| Sample | size | of grains | shock | shock | shock | Relative |
| No. | [μm] | [per μm²] | test | test | test | permittivity |
| 21 | 0.025 | 0.07 | 0/20 | 1/20 | 7/20 | 3183 |
| 22 | 0.015 | 0.23 | 0/20 | 0/20 | 3/20 | 3121 |
| 23 | 0.028 | 0.52 | 0/20 | 0/20 | 0/20 | 3144 |
| 6 | 0.020 | 0.82 | 0/20 | 0/20 | 0/20 | 3133 |
| 24 | 0.030 | 1.4 | 0/20 | 0/20 | 0/20 | 3108 |
| 25 | 0.028 | 1.8 | 0/20 | 0/20 | 0/20 | 3044 |
| 26 | 0.023 | 2.4 | 0/20 | 0/20 | 0/20 | 2849 |

According to Table 1, it was confirmed that the results of the 320° C. thermal shock test were better when the dielectric composition included the RE-Mg—Ti—O segregation grains 22 (Sample Nos. 5 to 7, 9, and 10) than when the dielectric composition did not include the RE-Mg—Ti—O segregation grains 22 (Sample Nos. 1 to 4 and 8).

### REFERENCE NUMERALS

1 . . . multilayer ceramic capacitor
10 . . . element body
2 . . . dielectric layer
20 . . . main phase grain
22 . . . . RE-Mg—Ti—O segregation grain
28 . . . grain boundary
3 . . . internal electrode layer
4 . . . external electrode

What is claimed is:

1. A dielectric composition comprising:
main phase grains; and
segregation grains,
wherein
the segregation grains at least partly comprise RE-Mg—Ti—O segregation grains including “RE”, Mg, Ti, and O;
“RE” comprises a rare earth element;
“RE”, Mg, and Ti in the RE-Mg—Ti—O segregation grains constitute 70 parts by mol or more in total out of 100 parts by mol of a total of metal elements in the RE-Mg—Ti—O segregation grains; and
a ratio of Mg to a total of “RE” and Mg in the RE-Mg—Ti—O segregation grains ranges from 0.1 to 0.3.

2. The dielectric composition according to claim 1, wherein the RE-Mg—Ti—O segregation grains are present in a grain boundary between the main phase grains.

3. The dielectric composition according to claim 1, wherein the RE-Mg—Ti—O segregation grains have an average grain size of 0.1 μm or less.

4. The dielectric composition according to claim 1, wherein an average number of the RE-Mg—Ti—O segregation grains observed in a total of 5 μm² or more of a section of the dielectric composition is 0.2 to 2 per μm².

5. The dielectric composition according to claim 1, wherein the main phase grains have a composition of BaTiO₃.

6. The dielectric composition according to claim 1, wherein the RE-Mg—Ti—O segregation grains have a composition of {RE₍₁₋ₐ₎Mgₐ}₂Ti₂O₇₋ₐ, where “a” ranges from 0.1 to 0.3.

7. An electronic component comprising the dielectric composition according to claim 1.
